(19) United States
(12) Patent Application Publication
(10) Pub. No.: US 2016/0036248 A1
(43) Pub. Date: Feb. 4, 2016

(54) PARALLEL MONITORING CIRCUIT FOR CAPACITOR

(71) Applicant: FUJI ELECTRIC CO., LTD., Kawasaki-shi (JP)

(72) Inventor: Yoshitaka HAMADA, Yokohama-city (JP)

(73) Assignee: FUJI ELECTRIC CO., LTD., Kawasaki-shi (JP)

(21) Appl. No.: 14/879,610

(22) Filed: Oct. 9, 2015

Related U.S. Application Data
(63) Continuation of application No. PCT/JP2013/076008, filed on Sep. 26, 2013.

(51) Int. Cl. H02J 7/00

(52) U.S. Cl. CPC H02J 7/007; H02J 7/0052; H02J 7/0068

(57) ABSTRACT

A capacitor charging-discharging system, including a plurality of serially connected capacitors, a voltage source for setting an equalization potential, and a plurality of parallel monitoring circuit. Each parallel monitoring circuit is connected to the two ends electrodes of one capacitor, and includes: a voltage dividing circuit configured to resistively divide and attenuate two voltages respectively on the two end electrodes of the one capacitor, a differential amplifier configured to amplify a difference between the two divided voltages to thereby detecting a charge potential of the one capacitor, a comparator configured to compare the charge potential with the equalization potential, and a charge current bypass circuit configured to control charge current of the one capacitor, based on an output of the comparator, so that the charge potential of the one capacitor matches the equalization potential.

### CROSS-REFERENCE TO RELATED APPLICATIONS

This application is a continuation application under 35 U.S.C. §120 of International Application PCT/JP2013/076008 having the International Filing Date of Sep. 26, 2013. The identified application is fully incorporated herein by reference.

### BACKGROUND OF THE INVENTION

1. Technical Field

The present invention relates to a parallel monitoring circuit that is connected in parallel with a corresponding capacitor from a plurality of capacitors connected in series, and that controls the charging current thereof to equalize the charge potentials of the capacitors.

2. Background Art

A capacitor charge-discharge system disclosed in Japanese Patent Application Publication No. 2008-271722 (hereinafter “JPAP'722”; see, e.g., paragraphs [0016] to [0019] and FIG. 1 of JPAP'722) is known as the conventional means for equalizing a charge potential of a plurality of electrical double layer capacitors connected in series.

FIG. 2 is a circuit diagram illustrating the charge-discharge system disclosed in JPAP'722. In FIG. 2, C₁, C₂, . . . , Cₙ are electrical double layer capacitors connected in series between a charging current source 10 and the GND (ground); reference numeral 20 is a load connected in parallel with the series circuit of the electrical double layer capacitors C₁, C₂, . . . , Cₙ; PMC₁, PMC₂, . . . , PMCₙ are parallel monitoring circuits of the same configuration which are connected in parallel to respective capacitors; CMP₁, CMP₂, . . . , CMPₙ are comparators; Vᵣ₁, Vᵣ₂, . . . , Vᵣₙ are equalization potentials of the capacitors which are provided as reference potentials (usually, Vᵣ₁=Vᵣ₂= . . . =Vᵣₙ=Vᵣ and equals to the full charge potential of each capacitor); R₁, R₂, . . . , R₃ are resistors for current restriction, and Tr₁, Tr₂, . . . , Trₙ are transistors for current bypass.

With such a conventional technique, the comparators CMP₁, CMP₂, . . . , CMPₙ compare the difference in potentials between the terminals of the capacitors C₁, C₂, . . . , Cₙ, that is, the charge potential of the capacitors C₁, C₂, . . . , Cₙ, with the equalization potential Vᵣ. Where the charge potential is less than Vᵣ, the transistor is switched OFF, and charging of the capacitor is continued, and where the charge potential is greater than Vᵣ, the transistor is switched ON, the charging current is bypassed, and charging of the capacitor is stopped, thereby performing equalization charging of all of the capacitors C₁, C₂, . . . , Cₙ.

In JPAP'722, as depicted in FIG. 2, the lower-potential side of each capacitor is connected to an inverting input terminal of each comparator through a voltage source that generates the equalization potential Vᵣ, and the upper-potential side of each capacitor is connected to the non-inverting input terminal of each comparator. Such a circuit configuration is disclosed not only in JPAP'722, but also in other literature.

However, in such a circuit configuration, the voltage source that generates the equalization potential Vᵣ is needed for each capacitor and is not shared. The resultant problem is that the circuit configuration is complex. Further, since the equalization potential Vᵣ has a fixed value, the charge potential cannot be changed and the capacitors cannot be equalization charged to a random value.

A capacitor charge control circuit disclosed in Japanese Patent Application Publication No. 2008-178202 (hereinafter “JPAP'202”; see, e.g., paragraphs [0032] to [0042] and FIGS. 3 and 4 of JPAP'202) is known as the conventional means for resolving the above-described problems.

FIG. 3 is a block diagram illustrating the capacitor charge control circuit disclosed in JPAP'202. In FIG. 3, PMC₁₁, PMC₁₂, . . . , PMC₁ₙ are parallel monitoring circuits of the same configuration that are connected in parallel with respective electrical double layer capacitors C₁, C₂, . . . , Cₙ; 31 is a voltage-current conversion circuit; 32 is a current-voltage conversion circuit (trimming resistor); 33 is a capacitor voltage division circuit; 34 is a bypass element drive circuit; 35 is a bypass element; 40 is a reference voltage generation circuit; 50 is a decoder; and 60 is a D-A (digital-to-analog) converter.

FIG. 4 depicts a specific circuit of the capacitor charge control circuit depicted in FIG. 3; here, 70 is a control circuit generating a control signal which is input to the decoder 50 on the basis of the voltages V_{c1}, V_{c2}, . . . of the capacitors C₁, C₂, . . . .

In this conventional configuration, the equalization potential Vᵣ input to a comparator 34a in the bypass element drive circuit 34 can be easily changed by using the D-A converter 60. Another advantage is that as a result of providing the voltage-current conversion circuit 31 and the current-voltage conversion circuit 32 before inputting the equalization potential Vᵣ to the comparator 34a, the D-A converter 60, which is the source of the equalization potential Vᵣ, can be shared by all of the capacitors C₁, C₂, . . . , Cₙ.

### BRIEF SUMMARY OF THE INVENTION

With the conventional configuration disclosed in JPAP'722 (see FIG. 2 described hereinabove), the upper-potential side of each capacitor is directly connected to the non-inverting input terminal of the comparator. Therefore, the voltage applied to the non-inverting input terminal is the same as the power supply voltage of the comparator. In particular, where power is supplied from the two end electrodes of each capacitor to the comparator, the voltage applied to the non-inverting input terminal becomes equal to the power supply voltage of the comparator.

In the case of a commonly used comparator, the common-mode input voltage range of at least about 1 V is specified for the power supply voltage. Therefore, where the input voltage is the same as the power supply voltage, unpredictable operation occurs and the device can be damaged. In order to avoid such a problem, it is necessary to select a special comparator of the so-called input rail-to-rail type which can be adapted even to the input voltage substantially equal to the power supply voltage.

Further, where power is supplied not from the two end electrodes of the capacitor, a comparator with a high breakdown voltage should be selected. This is because where power is supplied not from the two end electrodes of the capacitor, since the negative power supply terminal of each comparator is connected to the GND (0 V), the highest potential, with respect to the GND (0 V), of a plurality of electrical double layer capacitors, which has been connected in series to increase voltage, differs depending on the application and can reach several hundreds of volts in high-voltage applications, and a comparator corresponding to a capacitor close to this highest potential inputs a higher voltage.

Meanwhile, with the conventional configuration disclosed in JPAP'202 (see FIGS. 3 and 4 described hereinabove), a restriction is placed on the equalization potential which can be set.

The full charge potential per one electrical double layer capacitor is usually about 2 V to 3 V. By contrast, even special devices that can be driven by a low voltage require an operation power supply voltage of the comparator of about 1 V. In JPAP'202, for example, where the voltage-dividing resistance values of the capacitor voltage dividing circuit 33 are equal to each other when the capacitors are charged to about 1 V, the input voltage to the comparator is 0.5 V. To prevent the comparator from malfunctioning even in this state, it is necessary to select a special comparator of the input rail-to-rail type in the same manner as in the case described in JPAP'722. Further, even when such a special comparator is selected, the operation of the comparator cannot be guaranteed when the charge potential of the capacitor is less than the operation power supply voltage of the comparator.

Therefore, in JPAP'202, the equalization potential, which is set for the comparator 34a, is prescribed to be equal to or higher than the operation power supply voltage of the comparator.

Further, in the circuit disclosed in JPAP'202, since an N-MOS (N-type metal-oxide-semiconductor field-effect transistor) is used for the voltage-current conversion circuit 31, the equalization potential which is set for the comparator 34a is also prescribed to be equal to or higher than the threshold voltage (usually about 0.6 V to 0.7 V) of the N-MOS.

As described hereinabove, in the conventional configurations disclosed in JPAP'722 and JPAP'202, a special comparator sometimes needs to be selected for a bypass current, and various restrictions are placed on the lower limit value of the equalization potential. The resultant problem is that equalization charging of a plurality of capacitors cannot be performed at a potential lower than the lower limit value.

Accordingly, an objective to be attained by the present invention is to provide a parallel monitoring circuit that can use generally used comparators and can perform equalization charging of a plurality of serially connected capacitors at the desired potential.

In order to resolve the abovementioned problems, the invention provides in one embodiment a parallel monitoring circuit for a capacitor, the circuit being connected to both ends of a corresponding capacitor from among a plurality of serially connected capacitors and including: comparison means for comparing a charge potential of the capacitor with an equalization potential; and charge current bypass means operated by an output of the comparison means and controlling a charge current of the capacitor such that the charge potential matches the equalization potential.

The specific feature of the present invention is that the parallel monitoring circuit is provided with voltage dividing means for resistively dividing and attenuating a potential of two end electrodes of the capacitor; differential amplification means for amplifying a difference between the divided voltages obtained with the voltage dividing means and detecting the charge potential; and equalization potential setting means for setting the equalization potential as a variable value, wherein the comparison means compares the charge potential detected by the differential amplification means with the equalization potential which has been set by the equalization potential setting means.

In one embodiment of the invention, the voltage dividing means resistively divides a voltage between a ground potential and the potential of two end electrodes of the respective capacitors.

In one embodiment of the invention, a voltage attenuation ratio determined by the voltage dividing means is equal to an inverse value of a voltage amplification ratio in the differential amplification means.

In one embodiment of the invention, the equalization potential setting means can set the equalization potential at predetermined magnitude between 0 V and the full charge equivalent value of the capacitor.

In one embodiment of the invention, the operation power supply voltages of the differential amplification means and comparison means are supplied from a power supply other than the two end electrodes of the capacitor.

In accordance with the present invention, the equalization charging of a plurality of capacitors connected in series can be performed to an unrestricted desired value, without using a special comparator of an input rail-to-rail type or a comparator and an operational amplifier with a high voltage resistance.

### BRIEF DESCRIPTION OF THE DRAWINGS

FIG. 1 is a circuit diagram of a parallel monitoring circuit according to an embodiment of the present invention.

FIG. 2 is the circuit diagram of the capacitor charge-discharge system disclosed in JPAP'722.

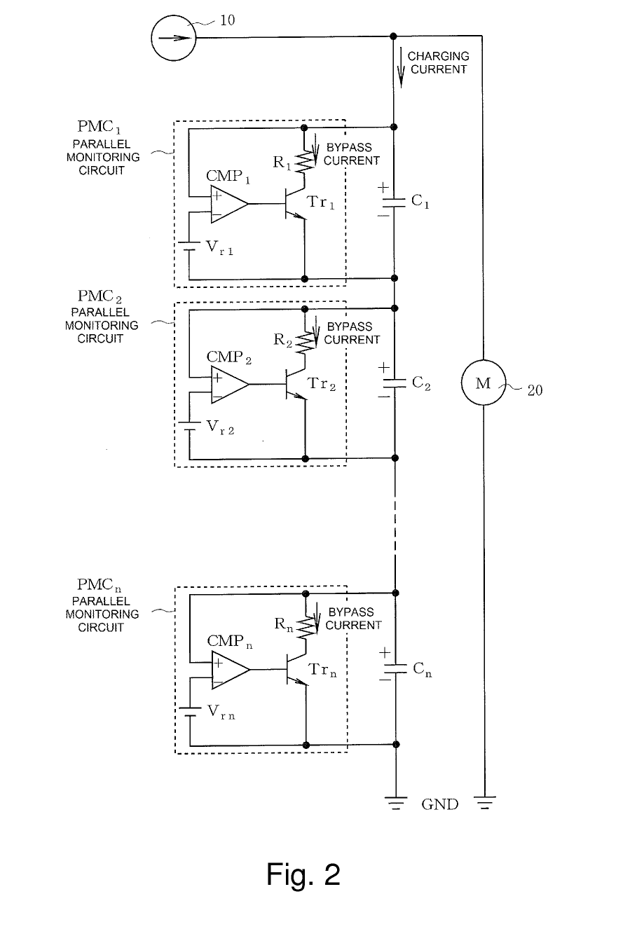

FIG. 3 is the block diagram of the capacitor charge-discharge system disclosed in JPAP'202.

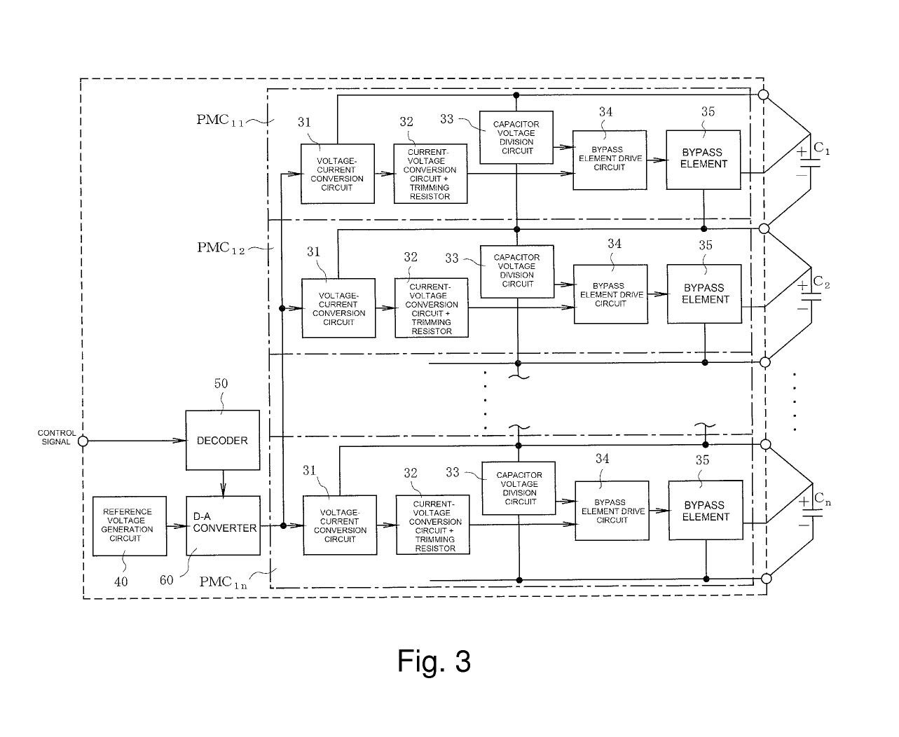

FIG. 4 is a specific circuit diagram of the capacitor charge-discharge system depicted in FIG. 3.

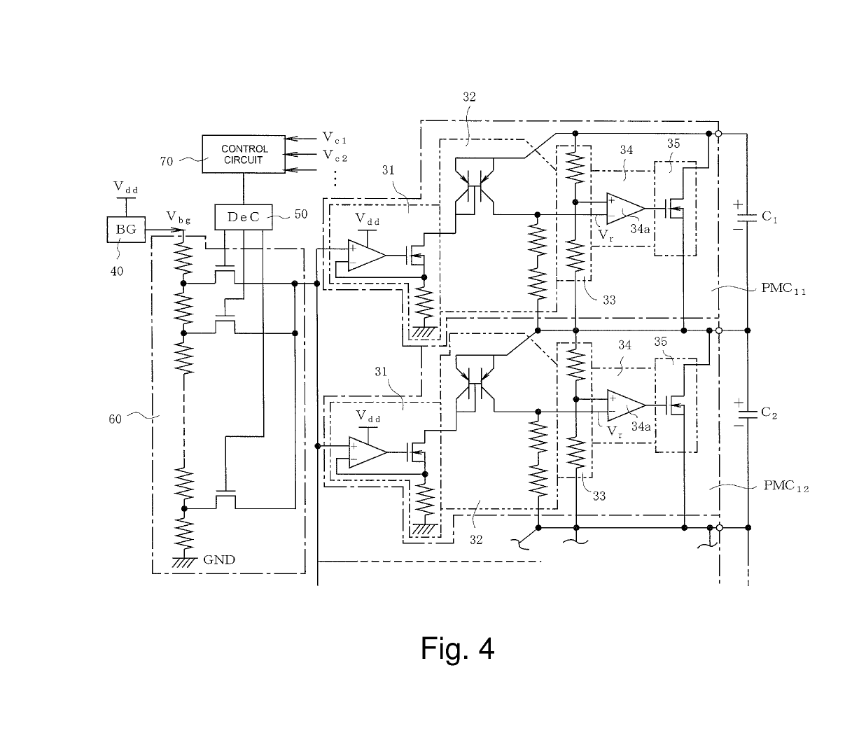

### DETAILED DESCRIPTION OF THE INVENTION

An embodiment of the present invention will be explained hereinbelow with reference to the drawings.

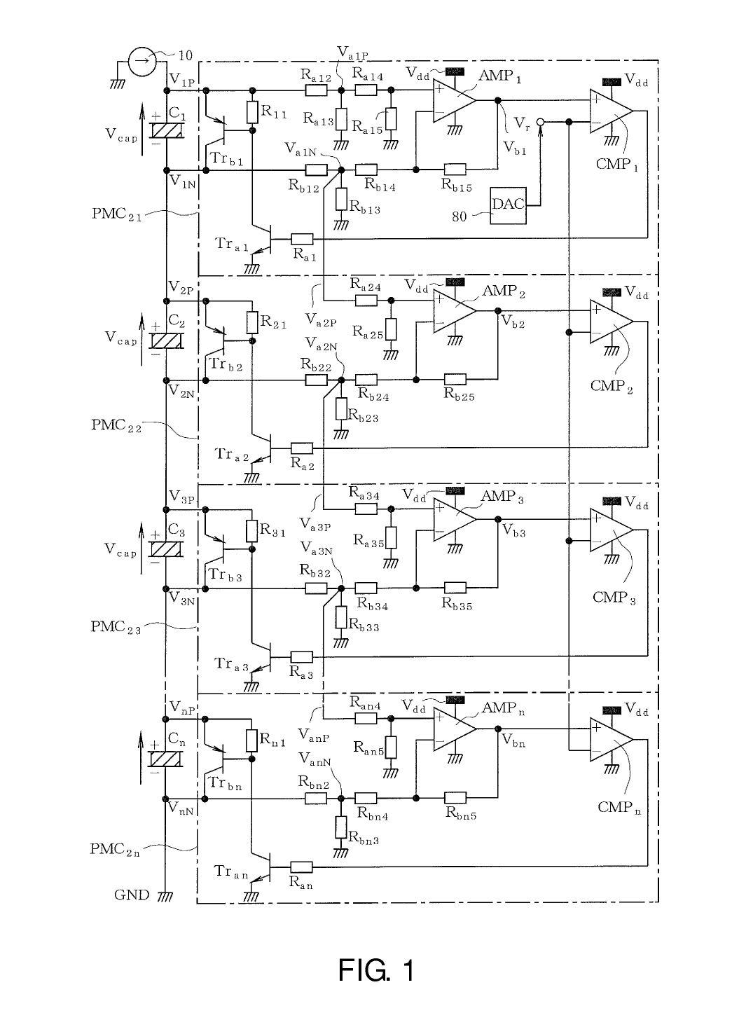

FIG. 1 is a circuit diagram of a parallel monitoring circuit according to one embodiment of the invention. In FIG. 1, capacitors such as electrical double layer capacitors C₁, C₂, C₃, . . . , Cₙ are connected in series between a charging current source 10 and the GND (ground), and parallel monitoring circuits PMC₂₁, PMC₂₂, PMC₂₃, . . . , PMC₂ₙ are connected to both ends of the respective capacitors C₁, C₂, C₃, . . . , Cₙ.

In this configuration, the charge potentials of all of the capacitors C₁, C₂, C₃, . . . , Cₙ are to be controlled to the same value by the operation of the parallel monitoring circuits PMC₂₁, PMC₂₂, PMC₂₃, . . . , PMC₂ₙ.

Since the parallel monitoring circuits PMC₂₁, PMC₂₂, PMC₂₃, . . . , PMC₂ₙ have substantially the same configuration, the configuration thereof is explained hereinbelow by considering mainly the parallel monitoring circuit PMC₂₁ on the highest potential side by way of example.

In the parallel monitoring circuit PMCₘ, an emitter and a collector of a PNP transistor Tr_{b1} are respectively connected to two end electrodes of the capacitor C₁, and a resistor R₁₁ is connected between the emitter and a base of the PNP transistor Tr_{b1}. A collector and an emitter of a NPN transistor Trₐ₁ are connected between the base of the transistor Tr_{b1} and the GND. Here, the transistors Tr_{b1}, Trₐ₁ and the below-described resistors Rₐ₁, R₁₁ and the like constitute the charge current bypass means or the charge current bypass circuit.

The output of a comparator CMP₁ is applied through the resistor Rₐ₁ to the base of the transistor Trₐ₁. An equalization voltage Vᵣ is applied from a D-A converter 80 serving as the equalization potential setting means, or a voltage source, to the inverting input terminal of the comparator CMP₁. This D-A converter 80 is shared with other parallel monitoring circuits PMC₂₂, PMC₂₃, . . . , PMC₂ₙ, and the equalization voltage Vᵣ is also applied to the inverting input terminals of the comparators CMP₂, CMP₃, . . . , CMPₙ.

The connection point of the resistor R₁₁ and the emitter of the transistor Tr_{b1} is connected through the series circuit of resistors Rₐ₁₂, Rₐ₁₄ to the non-inverting input terminal of the operational amplifier AMP₁. Further, the connection point of the resistor Rₐ₁₂ and the resistor Rₐ₁₄ is connected through a resistor Rₐ₁₃ to the GND, and the non-inverting input terminal of the operational amplifier AMP₁ is connected through a resistor Rₐ₁₅ to the GND.

The collector of the transistor Tr_{b1} is connected through the series circuit of resistors R_{b12}, R_{b14}, R_{b15} to the output terminal of the operational amplifier AMP₁, and the connection point of the resistor R_{b12} and the resistor R_{b14} is connected through the resistor R_{b13} to the GND.

The connection point of the resistor R_{b12} and the resistor R_{b14} is connected through the resistor Rₐ₂₄ of the parallel monitoring circuit PMC₂₂ of the next stage to the non-inverting input terminal of an operational amplifier AMP₂. Therefore, the resistors R_{b12}, R_{b13} and resistors Rₐ₂₄, Rₐ₂₅ are connected between the high-potential-side electrode of the capacitor C₂ of the next stage and the non-inverting input terminal of the operational amplifier AMP₂ and have the same connection relationship as that of the resistors Rₐ₁₂, Rₐ₁₃ and Rₐ₁₄, Rₐ₁₅ with respect to the operational amplifier AMP₁ of the parallel monitoring circuit PMC₂₁.

The same is true for other parallel monitoring circuits PMC₂₃, . . . , PMC₂ₙ.

In the parallel monitoring circuits PMC₂₂, PMC₂₃, . . . , PMC₂ₙ, Trₐ₂, Trₐ₃, . . . , Trₐₙ are NPN transistors, Tr_{b2}, Tr_{b3}, . . . , Tr_{bn} are PNP transistors, AMP₂, AMP₃, . . . , AMPₙ are operational amplifiers, CMP₂, CMP₃, . . . CMPₙ are comparators, and R₂₁, R₃₁, . . . , Rₙ₁, Rₐ₂, Rₐ₃, . . . , Rₐₙ, Rₐ₂₄, Rₐ₂₅, R_{b22}, R_{b23}, R_{b24}, R_{b25}, Rₐ₃₄, Rₐ₃₅, R_{b32}, R_{b33}, R_{b34}, R_{b35}, Rₐₙ₄, Rₐₙ₅, R_{bn2}, R_{bn3}, R_{bn4}, R_{bn5} are resistors.

In the parallel monitoring circuits PMC₂₁, PMC₂₂, PMC₂₃, . . . , PMC₂ₙ, the resistors Rₐ₁₂, Rₐ₁₃, R_{b12}, R_{b13}, R_{b22}, R_{b23}, R_{b32}, R_{b33}, . . . , R_{bn2}, R_{bn3} are voltage-dividing resistors for dividing the potential of the two end electrodes of the capacitors C₁, C₂, C₃, . . . , Cₙ with respect to the GND (0 V). The resistance values of those voltage-dividing resistors Rₐ₁₂, Rₐ₁₃, R_{b12}, R_{b13}, R_{b22}, R_{b23}, R_{b32}, R_{b33}, . . . , R_{bn2}, R_{bn3} may be set such that divided voltages fit into the input voltage range of the operational amplifiers AMP₁, AMP₂, AMP₃, . . . , AMPₙ.

Further, the resistors Rₐ₁₄, Rₐ₁₅, R_{b14}, R_{b15}, Rₐ₂₄, Rₐ₂₅, R_{b24}, R_{b25}, Rₐ₃₄, Rₐ₃₅, R_{b34}, R_{b35}, . . . , Rₐₙ₄, Rₐₙ₅, R_{bn4}, R_{bn5} serve to set the amplification ratios of the respective differential amplification circuits, and the resistance values thereof fulfil the following conditions: Rₐ₁₄=R_{b14}, Rₐ₁₅=R_{b15}, Rₐ₂₄=R_{b24}, Rₐ₂₅=R_{b2}, . . . , Rₐₙ₅=R_{bn5}.

Further, the resistance values of those resistors Rₐ₁₄, Rₐ₁₅, . . . , R_{bn4}, R_{bn5} are made higher than the resistance values of the voltage-dividing resistors Rₐ₁₂, Rₐ₁₃, R_{b12}, R_{b13}, R_{b22}, R_{b23}, R_{b32}, R_{b33}, . . . , R_{bn2}, R_{bn3} to a degree such as not to distort the Voltages V_{a1P}, V_{a1N} (=V_{a2P}), V_{a2N} (=V_{a3P}), V_{a3N}, . . . , V_{a(n-1)N} (=V_{anP}), V_{anN} appearing at the respective voltage-dividing resistors.

The output voltage V_{b1} of the differential amplification circuit (operational amplifier AMP₁) in the parallel monitoring circuit PMC₂₁ can be determined from Expression 1.

$${V}_{b 1} = ( {V}_{a 1 P} - {V}_{a 1 N} ) \frac{{R}_{a 15}}{{R}_{a 14}} \\ where \\ {V}_{a 1 P} = {V}_{ 1 P} \times \frac{{R}_{a 13}}{{R}_{a 12} + {R}_{a 13}} , \\ {V}_{a 1 N} = {V}_{ 1 N} \times \frac{{R}_{b 13}}{{R}_{b 12} + {R}_{b 13}} , \\ {V}_{ 1 P} = {V}_{ 1 N} + {V}_{cap} \qquad [ Expression 1 ]$$

Therefore, where the resistance values of the resistors Rₐ₁₂, Rₐ₁₃, Rₐ₁₄, Rₐ₁₅ are determined such as to satisfy Expression (2), the output voltage V_{b1} of the differential amplification circuit becomes equal to the charge potential V_{cap} of the capacitor C₁ (V_{b1}=V_{cap}). Expression (2) indicates that the voltage attenuation ratio determined by the resistors Rₐ₁₂, Rₐ₁₃ serving as a voltage dividing means, or a voltage dividing circuit, is equal to the inverse value of the voltage amplification ratio in the differential amplification circuit.

$$\frac{{R}_{a 13}}{{R}_{a 12} + {R}_{a 13}} \times \frac{{R}_{a 15}}{{R}_{a 14}} = 1 \qquad [ Expression 2 ]$$

Thus, where the resistance values of the resistors Rₐ₁₂, Rₐ₁₃, Rₐ₁₄, Rₐ₁₅ are determined such as to satisfy Expression (2), the comparator CMP₁ compares the charge potential V_{cap} (voltage V_{b1}) of the capacitor C₁ with the equalization potential Vᵣ.

Further, in this embodiment, V_{b1}=V_{cap} and V_{cap} is usually equal to less than 2 V to 3 V, regardless of the number of capacitors connected in series. Therefore, the power supply voltage V_{dd} of all of the comparators may be, for example, about 5 V even when the common-mode input voltage range is taken into account. This power supply voltage V_{dd} is used commonly also for all of the operational amplifiers.

Concerning the voltage V_{b1} and equalization potential Vᵣ compared by the comparator CMP₁, when V_{b1}<Vᵣ, both transistors Trₐ₁, Tr_{b1} are OFF. Therefore, the current from the charging current source 10 flows to the capacitor C₁, without bypassing, the capacitor C₁ is charged and the charge potential V_{cap} approaches the equalization potential Vᵣ.

Further, where V_{b1}≧Vᵣ, both transistors Trₐ₁, Tr_{b1} are ON and the current from the charging current source 10 is bypassed. As a result, no current flows to the capacitor C₁ and charging is stopped.

Thus, the charge potential V_{cap} of each capacitor C₁, C₂, C₃, . . . , Cₙ depends on the equalization potential Vᵣ, and the equalization potential Vᵣ is common for all of the capacitors C₁, C₂, C₃, . . . , Cₙ. Therefore, where the equalization potential Vᵣ is variably controlled by the D-A converter 80, the charge potential V_{cap} of all of the capacitors C₁, C₂, C₃, . . . , Cₙ can be easily changed.

Further, in the present embodiment, the power supply voltage V_{dd} of the comparators CMP₂, CMP₃, . . . , CMPₙ, is supplied separately, rather than from the two end electrodes of the capacitors. Therefore, the comparators CMP₂, CMP₃, . . . , CMPₙ can operate irrespectively of the charge potential V_{cap} of the capacitors.

Thus, the V_{cap} of each capacitor C₁, C₂, C₃, . . . , Cₙ can be set such as to increase in steps, for example, of 0.1 V, from the state of 0 V, and the capacitors C₁, C₂, C₃, . . . , Cₙ can be equalization charged to the desired value in a range from 0 V to a potential corresponding to a full charge.

### INDUSTRIAL APPLICABILITY

The present invention can be used, for example, for equalization charging of various capacitor series circuits such as batteries for electric automobiles configured by connecting in series a plurality of electrical double layer capacitors.

1. A parallel monitoring circuit configured to be connected to two end electrodes of a capacitor, among a plurality of serially connected capacitors, for controlling charging of the capacitor, the parallel monitoring circuit comprising:
a voltage dividing circuit configured to resistively divide and attenuate two voltages respectively on the two end electrodes of the capacitor, to thereby obtain two divided voltages;
a differential amplifier configured to amplify a difference between the two divided voltages, to thereby detect a charge potential of the capacitor;
a voltage source configured to set an equalization potential;
a comparator configured to compare the charge potential of the capacitor with the equalization potential; and
a charge current bypass circuit configured to control charge current of the capacitor, based on an output of the comparator, so that the charge potential of the capacitor matches the equalization potential.

2. The parallel monitoring circuit according to claim 1, wherein
the voltage dividing circuit resistively divides the two voltages that are each between a ground potential and a potential of one of the two end electrodes of the capacitor.

3. The parallel monitoring circuit according to claim 2, wherein
a voltage attenuation ratio determined by the voltage dividing circuit is equal to an inverse value of a voltage amplification ratio in the differential amplifier.

4. The parallel monitoring circuit according to claim 3, wherein
the voltage source is configured to set the equalization potential at a predetermined magnitude between 0 V and a value equivalent to a full charge of the capacitor.

5. The parallel monitoring circuit according to claim 2, wherein
the voltage source is configured to set the equalization potential at a predetermined magnitude between 0 V and a value equivalent to a full charge of the capacitor.

6. The parallel monitoring circuit according to claim 1, wherein
a voltage attenuation ratio determined by the voltage dividing circuit is equal to an inverse value of a voltage amplification ratio in the differential amplifier.

7. The parallel monitoring circuit according to claim 1, wherein
the voltage source is configured to set the equalization potential at a predetermined magnitude between 0 V and a value equivalent to a full charge of the capacitor.

8. The parallel monitoring circuit for a capacitor according to claim 1, wherein
operation power of the differential amplifier and the comparator are supplied from a power supply other than the two end electrodes of the capacitor.

9. A method for a parallel monitoring circuit to control charging of a capacitor having two end electrodes, comprising:
connecting the parallel monitoring circuit to the two end electrodes;
resistively dividing and attenuating two voltages respectively on the two end electrodes of the capacitor, to thereby obtain two divided voltages;
amplifying a difference between the two divided voltages, to thereby detect a charge potential of the capacitor;
obtaining an equalization potential;
comparing the charge potential of the capacitor with the equalization potential; and
controlling charge current of the capacitor, based on a result of the comparison, so that the charge potential of the capacitor matches the equalization potential.

10. A capacitor charging-discharging system, comprising:
a plurality of serially connected capacitors, each capacitor having two end electrodes;
a voltage source configured to set an equalization potential; and
a plurality of parallel monitoring circuits, each connected to the two ends electrodes of one of the plurality of capacitors, for controlling charging of the one capacitor, and including:
a voltage dividing circuit configured to resistively divide and attenuate two voltages respectively on the two end electrodes of the one capacitor, to thereby obtain two divided voltages,
a differential amplifier configured to amplify a difference between the two divided voltages, to thereby detecting a charge potential of the one capacitor,
a comparator configured to compare the charge potential of the one capacitor with the equalization potential, and
a charge current bypass circuit configured to control charge current of the one capacitor, based on an output of the comparator, so that the charge potential of the one capacitor matches the equalization potential.
